(19) United States
(12) Patent Application Publication
(10) Pub. No.: US 2024/0408977 A1
(43) Pub. Date: Dec. 12, 2024

(54) METHOD FOR CONTROLLING ENERGY TRANSFER IN A VEHICLE COMBINATION

(71) Applicant: Volvo Truck Corporation, Göteborg (SE)

(72) Inventors: Hamid Yhr, Gråbo (SE); Helena Götlind, Hindås (SE)

(21) Appl. No.: 18/697,519

(22) PCT Filed: Oct. 6, 2021
(86) PCT No.: PCT/EP2021/077575

§ 371 Date: Apr. 1, 2024

(51) Int. Cl. B60L 15/38; B60L 58/13

(52) U.S. Cl. CPC B60L 15/38; B60L 58/13; B60L 2200/28; B60L 2200/36; B60L 2240/26; B60L 2240/622; B60L 2240/642; B60L 2240/645; B60L 2260/32; B60L 2260/54

(57) ABSTRACT

A method for controlling electrical energy transfer in a vehicle combination comprising at least a primary vehicle coupled to a secondary vehicle so as to form a coupled vehicle combination, the method comprising: receiving transportation mission data for the primary and secondary vehicle; determining a state-of-charge (SOC) value of the primary vehicle and a SOC value of the secondary vehicle; determining an energy consumption for each one of the primary and the secondary vehicles for completing at least one vehicle coupled driving segment; determining an energy consumption for each one of the primary and the secondary vehicles for completing vehicle uncoupled driving segments; and on the basis of the determined SOC values and determined energy consumptions, providing an energy transfer schedule for the transportation mission.

### TECHNICAL FIELD

The present disclosure relates to a method for controlling electrical energy transfer in a vehicle combination comprising a primary vehicle coupled to a secondary vehicle.

The present disclosure also relates to a control system as well as a vehicle combination comprising such a control system. The present disclosure is applicable to any types of vehicle combinations comprising at least a towing vehicle and a towed vehicle connected to each other by a coupling. In particular, the present disclosure relates to heavy-duty vehicles, such as trucks and construction equipment, and more specifically to a vehicle combination with powered dolly vehicles comprising one or more dolly vehicles.

Although the disclosure will mainly be described in relation to a vehicle combination in the form of a first autonomous vehicle and a second autonomous vehicle, such as an autonomous truck and an autonomous dolly, it may also be applicable for other types of vehicles such as vehicle combinations powered by an electric machine, including partly autonomous vehicle combinations, truck-powered trailer combinations etc. The present disclosure is also applicable to inductive couplings between the first vehicle and the second vehicle.

### BACKGROUND

In the field of heavy-duty vehicles there is an increasing demand for providing more efficient transportation vehicle systems, that may also be fully, or at least partly, autonomous. In an attempt to meet this demand, the operational capacity of heavy-duty vehicles can be increased by e.g. vehicle combinations with a plurality of vehicle units in the form of trailer units. As such, the vehicle combination is able to transport a substantive amount of material when driving from one position to another.

Furthermore, some vehicle combinations may include one or more dolly vehicles to allow for additional trailer units to be towed by the same tractor unit. In this manner, the cargo transport ability may be further extended. Dolly vehicles can be provided in several different configurations, such as traditional unpowered dolly vehicles 35 configured to connect with the tractor unit or another trailer. Other types of dolly vehicles may refer to powered dolly vehicles, such as electric-powered dolly vehicles, and/or steerable dolly vehicles. Dolly vehicles can also be configured to operate as partly or fully autonomous vehicles.

Although such vehicle combinations are commonplace today, the use of power and the distribution of e.g. traction power between the vehicle units are still oftentimes not satisfactory. There is thus a desire for improved systems and methods of controlling energy transfer in vehicle combinations including one or more vehicle, in particular for vehicle combinations including one or more electric dolly vehicles.

### SUMMARY

It is an object of the present disclosure to at least partially overcome the above described deficiencies and to provide a method of controlling electrical energy transfer between self-propelled vehicles of a coupled vehicle combination in a more optimal manner. This object is achieved by a method according to claim 1. The objective is also achieved by the other independent claims. The dependent claims are directed to advantageous embodiments of the disclosure.

According to a first aspect, there is provided a method for controlling electrical energy transfer in a vehicle combination comprising at least a primary vehicle articulated coupled to a secondary vehicle so as to form a coupled vehicle combination, each one of the primary and secondary vehicles having an electric machine and an energy storage system, ESS. The method comprises: receiving transportation mission data for the primary and secondary vehicle, the transportation mission data containing information of a vehicle coupled driving segment in which the primary and secondary vehicles are in a coupled vehicle combination for performing a part of a transportation mission and information of any vehicle uncoupled driving segments in which one of the primary and secondary vehicles is operated in an uncoupled state from the other one for performing another part of the transportation mission; determining a state-of-charge, SOC, value of the ESS of the primary vehicle and a SOC value of the ESS of the secondary vehicle; determining an energy consumption for each one of the primary and secondary vehicles for completing the at least one vehicle coupled driving segment; determining an energy consumption for each one of the primary and secondary vehicles for completing any vehicle uncoupled driving segments; and on the basis of the determined SOC values and determined energy consumptions, providing an energy transfer schedule for the transportation mission comprising one or more energy transfer operations for transferring energy between the primary and secondary vehicles.

The method of the present disclosure thus provides for an improved method for handling driving situations of a coupled vehicle combination in which one of the ESS of the vehicles of the coupled vehicle combination may be at risk of becoming discharged, or at least discharged to a level that the vehicle may not be capable of completing specific parts of the transportation. In other words, the provisions of the method allow for an improved energy sharing management between at least two vehicle units connected into a vehicle combination for performing transportation mission(s) in a coupled state and generally also in an uncoupled state. A further advantage of the present disclosure is to provide a more flexible and efficient transportation of cargo that needs to be delivered to several destinations, where parts of the cargo can be transported by the primary vehicle to one destination, while other parts of the cargo may be transported to another destination by the secondary vehicle. In this type of transportation mission, it may be particularly useful to allow for a transfer of electrical energy from one of the vehicles to the other vehicle in a coupled vehicle combination configuration so as to provide a reliable transportation of the cargo when the vehicles are in an uncoupled vehicle combination. The proposed method and system are particularly suitable for more autonomous transportation networks, where at least parts of the transportation may either be partly or fully autonomous. In this type of vehicle network, the proposed method allows for transportation of cargo in a more autonomous manner by means of a control system communicating with the primary vehicle and the secondary vehicle of the vehicle combination.

In other words, the method provides for transferring electrical energy between self-propelled vehicles coupled to each other so as to form a temporarily coupled vehicle combination, in which energy is transferable between the vehicles when the coupled vehicle combination is operated to complete a transportation mission, including e.g. a transportation of cargo in the coupled state to a first destination and additional transportation of cargo in an uncoupled state to additional destinations. In particular, a transfer of energy may only be performed on the basis of a more efficient and reliable energy management for the whole transportation mission. Several options and parameters for determining when energy transfer is needed between the vehicles will be described in the following.

The term “primary vehicle”, as used herein, may generally refer to a towing vehicle, e.g. a tractor, cab, truck or another towing powered dolly vehicle. The primary vehicle may either be a conventional towing vehicle, a semi-autonomous towing vehicle or an autonomous towing vehicle. According to at least one example embodiment, the primary vehicle is an autonomous vehicle such as an electric vehicle, hybrid vehicle, in particular an autonomous towing vehicle, autonomous tractor unit of a truck or another autonomous dolly vehicle. Further, while the primary vehicle may generally be an electric vehicle, the primary vehicle may likewise be a partly electrical vehicle such as a hybrid vehicle. The primary vehicle may also be a vehicle comprising an internal combustion engine (ICE), such as diesel-type ICE, hydrogen-based ICE or the like, and further having an energy storage system, such as a battery or a fuel cells system.

The term “secondary vehicle”, as used herein, may generally refer to a secondary vehicle of the vehicle combination, in particular a self-powered vehicle. According to at least one example embodiment, the secondary vehicle is a powered dolly vehicle, such as an autonomous dolly vehicle, e.g. an electric autonomous dolly vehicle.

According to at least one example embodiment, the secondary vehicle is a powered trailer, such as an electric-powered trailer. While the secondary vehicle may generally be a powered dolly vehicle or a powered trailer, the second vehicle may also be provided in other ways and also both with fully or partly electrical configurations.

As mentioned above, the vehicle combination is an articulated vehicle combination. An articulated vehicle combination refers to vehicle combination in which the primary vehicle is mechanically coupled to the secondary vehicle by an articulated mechanical coupling.

The term “powered dolly vehicle”, as used herein, may generally refer to a dolly vehicle operable as an independent vehicle unit and further configured to connect a pair of trailers to each other such that the trailers move with respect to each other when the vehicle combination is in motion. A powered dolly vehicle may generally include one or more driven axels and one or more steerable axles. A powered dolly vehicle is further self-powered. The powered dolly vehicle may be self-powered by an electric propulsions system, but may occasionally also be powered with another type of propulsion system, such as a hybrid propulsion system, including an internal combustion engine and an energy storage system in the form of a battery or a fuel cells system. According to one example embodiment, the powered dolly vehicle is an autonomous dolly vehicle. Autonomous dolly vehicles are self-powered vehicles and may provide both increased fuel efficiency and maneuverability. An autonomous dolly vehicle comprises one or more steerable axles for improved turning ability of the combination vehicle, since the dolly vehicle can be used to steer a second trailer as the vehicle combination turns in order to reduce the total area swept by the vehicle combination. According to at least one example embodiment, the powered dolly vehicle is an autonomous electric dolly vehicle.

It should also be noted that the vehicle combination may comprise additional vehicles and vehicle units, such as an additional autonomous dolly vehicle with corresponding trailers. Thus, the present disclosure is equally applicable for a vehicle combination comprising an arbitrary combination of vehicles, such as a third vehicle, a fourth vehicle, etc.

Further, it should be noted that the expression “autonomous vehicle”, as used herein, should be interpreted broadly and relates to a vehicle that is operated in a fully or partially autonomous mode. In a partially autonomous vehicle, some functions can optionally be manually controlled (e.g. by a driver) some or all of the time. Further, a partially autonomous vehicle may be configured to switch between a fully-manual operation mode and a partially-autonomous and/or a fully-autonomous operation mode. Each one of the autonomous vehicles may include a control unit, e.g. an electronic control unit (ECU), typically provided as an onboard component of the vehicle. Further, each one of the vehicles may generally comprise a number of appropriate sensors for operating the corresponding vehicle in an autonomous manner. Such sensors may include sensors for determining what is occurring in a surrounding of the vehicle, for example including at least one of a radar, a LiDAR sensor and/or a camera. Other sensors for measuring speed, acceleration, inclination, torque, vehicle mass, etc. may be equally used in determining a desired general action plan to be performed by the autonomous vehicle.

The term “vehicle coupled driving segment”, as used herein, typically refers to a transportation segment, such as road segment, in which the primary vehicle and secondary vehicle are operated in the coupled state along the driving segment for performing at least a part of the transmission mission. The term “vehicle uncoupled driving segment”, as used herein, typically refers to a transportation segment, such as road segment, in which the primary vehicle and secondary vehicle are operated in the decoupled state relative each other along the driving segment for performing at least another part of the transmission mission, including any decoupled state in which the primary vehicle is operated to perform transportation, a decoupled state in which the secondary vehicle is operated to perform transportation and a decoupled state in which both the primary vehicle and the secondary vehicle are operated to perform transportations. It should be noted that the term “uncoupled state” may sometimes also be denoted as an “uncoupled mode”, “uncoupled configuration” and the like. Analogously, the term “coupled state” and “vehicle coupled combination” may sometimes also be denoted as a “coupled mode”, “coupled configuration”, “coupled arrangement” and the like.

The electrical energy transfer between the primary vehicle and the secondary vehicle may be controlled in several different manners in view of the predicted parameters and conditions as mentioned herein. As such, the energy transfer schedule for the transportation mission may contain a number of different energy transfer operations between the vehicles in view of the various vehicle coupled driving segment(s) as well as the various vehicle uncoupled driving segment. In addition, the energy transfer schedule for the transportation mission may contain a number of different energy transfer operations between the vehicles in view of the occurrence, duration and the mutual order of the vehicle coupled driving segment(s) and the vehicle uncoupled driving segment. The following examples present particularly useful provisions for controlling energy transfer between the primary vehicle and the secondary vehicle.

According to at least one example embodiment, if the transportation mission data contains information for the secondary vehicle to perform a vehicle uncoupled driving segments after the at least one vehicle coupled driving segment, the one or more energy transfer operations may comprise transferring energy from the primary vehicle to the secondary vehicle if the determined SOC value of the secondary vehicle is below a threshold indicating a minimum SOC level and if the determined SOC value of the primary vehicle is above a threshold indicating a surplus level for the primary vehicle.

Typically, the energy transfer schedule may comprise determining a duration for the transfer of energy from the primary vehicle to the secondary vehicle during the vehicle coupled driving segment.

According to at least one example embodiment, if the transportation mission data contains information for the primary vehicle to perform a vehicle uncoupled driving segments after the at least one vehicle coupled driving segment, the one or more energy transfer operations may comprise transferring energy from the secondary vehicle to the primary vehicle if the determined SOC value of the primary vehicle is below a threshold indicating a minimum SOC level and if the determined SOC value of the secondary vehicle is above a threshold indicating a surplus level for the secondary vehicle.

By controlling the transfer of electrical energy on the basis of a threshold value of the ESS of the primary vehicle and a threshold value of the ESS of the secondary vehicle, it becomes possible to determine when it is particularly critical to transfer excessive energy from one of the vehicles to the other one of the vehicles. An advantage is thus that energy in one vehicle may only be possible to transfer in certain situations where there is a specific need for the other vehicle to be charged in order to complete the transportation mission. Such situation may e.g. be a common transportation mission including delivery of cargos to more than one location, where vehicle combination in a coupled mode should deliver cargo to a first destination, while the secondary vehicle may deliver cargo to a second destination in a decoupled mode from the primary vehicle. In this manner, it becomes possible to improve the overall energy use of the entire vehicle combination on the basis of the SOC of the vehicle combination and the transportation destination(s) of the cargo. Another situation may be when the secondary vehicle is operated in a decoupled mode from the primary vehicle at a last part of the common transportation mode in order to return to its logistics area.

Typically, the energy transfer schedule may comprise determining a duration for the transfer of energy from the secondary vehicle to the primary vehicle during the vehicle coupled driving segment.

According to at least one example embodiment, if the transportation mission data contains information for any one of the primary and secondary vehicles to perform a vehicle uncoupled driving segments prior to the at least one vehicle coupled driving segment, the method may further comprise determining if the corresponding determined vehicle SOC values are sufficient for the vehicle uncoupled driving segments on the basis of the corresponding determined energy consumptions for the vehicle uncoupled driving segments.

By way of example, the energy consumption of an individual vehicle of any one of the primary and secondary vehicles in any vehicle uncoupled driving segments is calculated on the basis of the individual weight of the individual vehicle including any payload on the individual vehicle.

In a similar vein, the energy consumption for the primary vehicle in the at least one vehicle coupled driving segment may be calculated based on the total weight of the primary vehicle and the total weight of the secondary vehicle including any payload on the primary and secondary vehicles.

The energy transfer schedule may comprise initiating energy transfer between the primary vehicle and the secondary vehicle prior to commencing the transportation mission or during the transportation mission.

According to at least one example embodiment, the method may further comprise receiving driving data or driver data from any one of the primary and secondary vehicles during the vehicle coupled driving segment and any one of the vehicle uncoupled driving segments, and adjusting the one or more energy transfer operations of the energy transfer schedule on the basis of the received driving data or driver data.

Typically, the provision of determining an energy consumption for each one of the primary and secondary vehicles for the vehicle uncoupled driving segments may further comprise using vehicle and driving characteristics for a previous transportation along any one of the corresponding vehicle uncoupled driving segments.

In addition, or alternatively, the provision of determining an energy consumption for each one of the primary and secondary vehicles for the vehicle coupled driving segment may further comprise using vehicle and driving characteristics for a previous transportation along the corresponding vehicle coupled driving segments.

According to at least one example embodiment, the provision of providing an energy transfer schedule for the transportation mission may comprise adjusting the one or more energy transfer operations on the basis of at least one of the following additional data: data indicating type of vehicle of the vehicle combination, data indicating type of braking system of the vehicle combination, characteristics of the electric machine in any one of the vehicles, type of auxiliary vehicle power system in any one of the vehicles.

According to at least one example embodiment, the provision of providing an energy transfer schedule for the transportation mission may comprise adjusting the one or more energy transfer operations on the basis of data relating to environmental conditions.

The transportation mission data may comprise route information describing a route from a starting point to a destination. Typically, the transportation mission data may further comprise a mission-characteristic for the vehicle combination. By way of example, the mission-characteristic of the vehicle combination comprises any one of an assignment instruction for the vehicle combination, a cargo space-requirement for the vehicle combination, a pick-up location(s) of the cargo, a pick-up time for the cargo, a delivery time for the cargo, a delivery location(s) of the cargo, and data indicating type of cargo. In addition, or alternatively, the mission-characteristic of the vehicle combination comprises data indicating type of primary vehicle.

According to at least one example embodiment, the transfer of electrical energy is performed by means of an inductive coupling between the primary vehicle and the secondary vehicle. An inductive coupling between the primary vehicle and the secondary vehicle provides for a more secure and safer transfer of energy between the vehicles. According to at least one example embodiment, the transfer of electrical energy is performed by means of a conductive coupling between the primary vehicle and the secondary vehicle. This type of coupling may provide for a more efficient type of energy transfer between the vehicles. A conductive coupling may comprise corresponding connectors arranged on the primary and secondary vehicles.

Optionally, the method may further comprise controlling the energy transfer between the primary and secondary vehicles based on the provided energy transfer schedule. By way of example, the method comprising controlling the energy transfer between the primary and secondary vehicles according to any one of the one or more energy transfer operations, as mentioned above.

According to a second aspect, there is provided a control system comprising a processing circuitry configured to perform the steps of the method according to the above described first aspect. In other words, the processing circuitry is configured to perform the method and any one of the steps according to the above described first aspect. Further effects and features of the second aspect are largely analogous to those described above in relation to the first aspect.

The control system may include one or more control units comprised on-board each one of the vehicles of the vehicle combination. The control system and each one of the corresponding control units may include a microprocessor, microcontroller, programmable digital signal processor or another programmable device. The control system and each one of the corresponding control units may comprise modules in either hardware or software, or partially in hardware or software and communicate using known transmission buses such as CAN-bus and/or wireless communication capabilities. The processing circuitry may be a general purpose processor or a specific processor. The control system and each one of the corresponding control units typically comprises a non-transistory memory for storing computer program code and data upon. Thus, the control unit may be embodied by many different constructions. While the example embodiments of the control system described above can include one or more control units being integral parts thereof, it is also possible that the one or more control units may be separate parts of the vehicle combination, and/or arranged remote from the vehicle combinations and in communication with each one of the vehicles of the vehicle combination. Parts of the control system may also be provided in the form of a cloud server arranged in networked communication with the vehicle combination. Parts of the control system may also be implemented using a cloud server being network connected to an electronic control unit (ECU) comprised with the vehicle combination.

Optionally, the control system may also comprise a remote-control unit. Optionally, any one of the control units may be connected to the remote-control unit or server via a wireless link. This remote-control unit may be connected to a communications network, such as a communications network defined by the third-generation partnership program, 3GPP. Examples of such networks include 4G, 5G and 6G communication networks, as well as networks in the 802.11 family, in particular 802.11p. The remote-control unit may, e.g., be comprised in a control tower arranged to control powered dolly vehicles in a cargo terminal. In this case, the powered dolly vehicle is configured to enter into a slave mode configuration and receive requests from the control tower in a way similar to when it is connected to a master towing vehicle.

According to a third aspect, there is provided a computer program comprising program code means for performing the steps of any one of the embodiments described above in relation to the first aspect when the program is run on a computer or on processing circuitry of a control system. The computer program may be stored or distributed on a data carrier. As used herein, a “data carrier” may be a transitory data carrier, such as modulated electromagnetic or optical waves, or a non-transitory data carrier. Non-transitory data carriers include volatile and non-volatile memories, such as permanent and non-permanent storages of magnetic, optical or solid-state type. Still within the scope of “data carrier”, such memories may be fixedly mounted or portable.

According to a fourth aspect, there is provided a computer readable medium carrying a computer program comprising program means for performing the steps of any one of the embodiments described above in relation to the first aspect when the program means is run on a computer or on processing circuitry of a control system.

According to a fifth aspect, there is provided a vehicle combination formed by a primary vehicle and a secondary vehicle. The vehicle combination comprises a control system according to the above described second aspect for performing the steps of any one of the embodiments described above in relation to the first aspect.

By way of example, the primary vehicle is any one of an autonomous vehicle, such as an autonomous towing vehicle, autonomous tractor of a truck, and an autonomous dolly vehicle. By way of example, the secondary vehicle is any one of an autonomous dolly vehicle and a trailer. The trailer may be a powered trailer unit.

According to at least one example embodiment, the vehicle combination is an articulated vehicle combination, comprising a primary vehicle in the form of tractor unit, a first trailer unit coupled to the tractor unit by a first articulated coupling, a secondary vehicle in the form of a powered dolly vehicle, the powered dolly vehicle being coupled to the first trailer unit by a second articulated coupling, a second trailer unit coupled to the powered dolly by a third articulated coupling, and the control system according to the above described second aspect for performing the steps of any one of the embodiments described above in relation to the first aspect.

According to a sixth aspect, there is provided a vehicle for forming a vehicle combination with another vehicle, the vehicle comprising a control system according to the above described second aspect for performing the steps of any one of the embodiments described above in relation to the first aspect, when coupled to the another vehicle.

Effects and features of the third, fourth, fifth and sixth aspects are largely analogous to those described above in relation to the first and second aspects.

Further features of, and advantages will become apparent when studying the appended claims and the following description. The skilled person will realize that different features may be combined to create embodiments other than those described in the following, without departing from the scope of the present disclosure.

### BRIEF DESCRIPTION OF THE DRAWINGS

The above, as well as additional objects, features and advantages, will be better understood through the following illustrative and non-limiting detailed description of exemplary embodiments, wherein:

FIGS. 1a and 1b are lateral sides view illustrating an example embodiment of a vehicle combination in the form of a primary vehicle and a secondary vehicle, in which the primary vehicle is an autonomous truck and the secondary vehicle is an autonomous dolly coupled to a trailer;

FIG. 2 schematically shows a control system for controlling energy transfer between the vehicles of the vehicle combination in FIGS. 1a and 1b according to an example embodiment;

FIG. 3 schematically shows a control system for controlling energy transfer between the vehicles of the vehicle combination in FIGS. 1a and 1b according to another example embodiment; and

FIG. 4 is a flow chart of a method for controlling energy transfer between the vehicles of the vehicle combination in FIGS. 1a and 1b according to an example embodiment of the disclosure.

### DETAILED DESCRIPTION

The present disclosure will now be described more fully hereinafter with reference to the accompanying drawings, in which exemplary embodiments are shown. The disclosure may, however, be embodied in many different forms and should not be construed as limited to the embodiments set forth herein; rather, these embodiments are provided for thoroughness and completeness. Like reference character refer to like elements throughout the description.

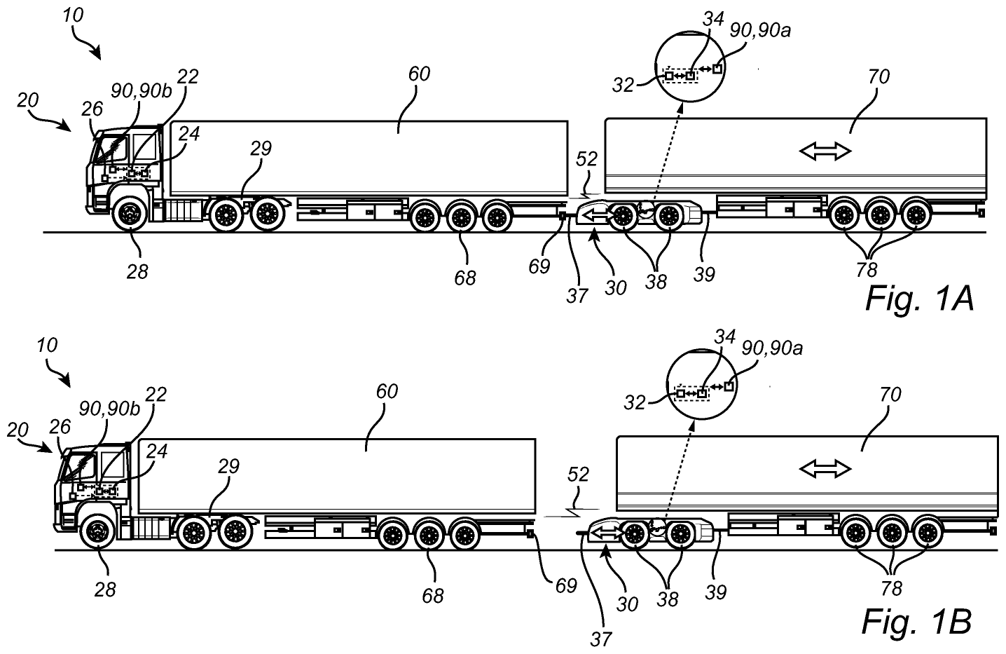

Referring now to the drawings and to FIGS. 1a and 1b in particular, there is depicted an exemplary vehicle combination 10 in the form of a primary vehicle 20 configured to be coupled to a powered dolly vehicle 30. The vehicle combination is particularly suitable for cargo transport where the herein disclosed techniques can be applied with advantage. In FIGS. 1a and 1b, the vehicle combination 10 comprises a primary vehicle in the form of an autonomous truck 20 and a secondary vehicle in the form of an autonomous dolly vehicle 30. Moreover, the autonomous truck 20 here comprises a tractor unit and a semi-trailer 60. However, the autonomous truck 20 may likewise be operated without a semi-trailer. The vehicle combination 10 here also comprises a second trailer 70 coupled to the rear part of the dolly vehicle 30. That is, the autonomous dolly vehicle 30 is configured to be coupled to a second trailer 70. The trailer 70 is here a conventional non-powered trailer, but may likewise be a powered trailer, such as an electrified trailer. Furthermore, FIG. 1a illustrates the vehicle combination when the autonomous truck 20 and the autonomous dolly vehicle 30 are in a coupled arrangement, while FIG. 1b illustrates the vehicle combination 10 in an uncoupled arrangement. The term coupled arrangement refers to a coupled vehicle combination of the primary and secondary vehicles, while the term uncoupled arrangement refers to an uncoupled state between the primary and the secondary vehicles. In the uncoupled state, the primary vehicle is operable separately from the secondary vehicle, while the secondary vehicle is operable separately from the primary vehicle. It should be readily appreciated that the vehicle combination may be provided in several different ways. By way of example, the primary vehicle may be provided in the form of an autonomous dolly vehicle and the powered dolly vehicle in the form of another autonomous dolly vehicle, each one of the dollies having corresponding trailers. It should be noted that the primary vehicle and the secondary vehicle may necessary not always be autonomous vehicles, but other types of vehicles are likewise conceivable, as will be readily appreciated from the disclosure.

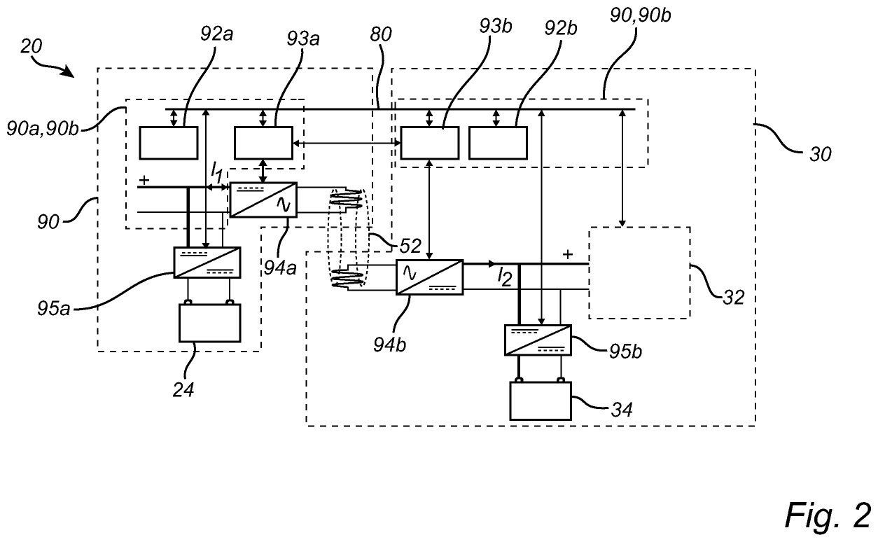

Generally, each one of the vehicles of the vehicle combination comprises corresponding control units 90a, 90b forming parts of a control system 90, as will be further described in relation to FIGS. 2 to 4. The control system may of course also be implemented in other types of vehicle combinations and in several different configurations in view of the types of vehicles and type of control system. The control system 90 may communicate by wire or in a wireless fashion with other control units and systems.

For ease of reference, the autonomous truck may herein simply be denoted as the truck 20, while the autonomous powered dolly vehicle may simply be denoted as the powered dolly vehicle, or the dolly vehicle 30.

While the propulsion systems of the vehicles of the vehicle combination may be provided in several different ways, the primary propulsion system of each one of the truck 20 and the dolly vehicle 30 is here an electric propulsion system. Hence, each one of the vehicles 20 and 30 comprises a corresponding electric machine 22 and 32 and a corresponding energy storage system, ESS, 24 and 34. If the trailer 70 is an electrified trailer, the trailer may comprise a corresponding electric machine and ESS (not shown). By way of example, the ESS is a high voltage battery, as is commonly known in the art. The electric machines of the vehicles are generally arranged to provide traction power to the corresponding vehicles, and to the vehicle combination when the vehicles are coupled to each other. Further, as is commonly known in the art, each one of the electric machines 22 and 32 are typically operable in a generator mode for generating electrical energy during a regenerative braking event of the corresponding vehicle.

Moreover, each one of the vehicles 20, 30 and the trailer 70 here comprises at least two pair of wheels 28, 38 and 78, but may often include a number of additional pair of wheels. If the vehicles 20 and 30 are autonomous vehicles, at least some of the pair of wheels of each vehicle are driven by means of the electric machines. It may also be noted that the semi-trailer 60 may have corresponding wheels 68. It should be readily appreciated that several different configurations may be conceivable depending on type of vehicle combination. By way of example, the truck 20 may likewise be a diesel-type truck with an internal combustion engine, or a hybrid truck including an internal combustion engine and the electric machine, where the ESS is provided in the form of a 48-voltage system rather than a high voltage system. In such example, the secondary vehicle is typically a full-electric vehicle.

If the electric machine 32 of the dolly vehicle 30 is in the generator mode for generating electrical energy during the braking event, the electric machine 32 is operable to apply a regenerative braking force to at least one of the wheels 38, or a pair of wheels, of the dolly vehicle 30 so as to convert kinetic energy to electrical energy. The generated electricity may be transferred to the truck 20.

The vehicles of the vehicle combination can be mechanically coupled to each other in several different ways, e.g. by an articulated coupling. By way of example, as illustrated in FIGS. 1a and 1b, the truck 20 comprises a fifth wheel configuration 29 for the trailer 60. The dolly vehicle 30 in FIGS. 1a and 1b, however, comprises a front drawbar connection 37 for coupling with the trailer 60 and a rear drawbar connection 39 for coupling with the trailer 70. Analogously, the trailer 60 comprises the drawbar connection 69 for coupling to the dolly vehicle 30. In addition, or alternatively, one or more of the vehicles of the vehicle combination may be mechanically coupled to each other by means of a conventional fifth wheel configuration. In the example embodiment illustrated in FIGS. 1a and 1b, it should be noted that drawbar connection generally refers to a two-piece connection, where a draw-bar attachment mechanism is arranged on one of the vehicles while a drawbar is arranged on the other vehicle.

In other words, the vehicle combination in FIGS. 1a and 1b illustrates an arrangement of a number of vehicles so as to extend the cargo transport capability of the vehicle combination. In this type of vehicle combination, the dolly vehicle 30 can e.g. be connected to the rear of the first trailer 60. This dolly vehicle 30 can then tow a second trailer 70, as illustrated in e.g. FIG. 1b. In other conceivable vehicle combinations, on the other hand, the dolly vehicle 30 is the towing vehicle and operates in an autonomous, or at least in a partly semi-autonomous manner. The dolly vehicle 30 can then autonomously or via remote control maneuver the trailer unit, for instance to park the trailer.

It is also conceivable that more than one dolly vehicles 30 can be added to a vehicle combination in order to tow more than one extra trailer unit. The vehicle combination arrangements disclosed herein may also be extended to multiple trailers towed by one tractor. It may also be possible that the dolly vehicle comprise one or more steerable axles for improving turning ability of the combination vehicle, since the dolly vehicle can be used to steer the second trailer unit 70 as the vehicle combination turns in order to reduce the total area swept by the vehicle combination.

As mentioned above, the vehicle combination 10 comprises the control system 90. The control system 90 is generally configured to perform a method for controlling energy transfer between coupled vehicles of the vehicle combination 10. In the following description of the control system 90 and the method for controlling energy transfer between the vehicles, the primary vehicle will be referred to as the truck 20, while the secondary vehicle will be referred to as the dolly vehicle 30.

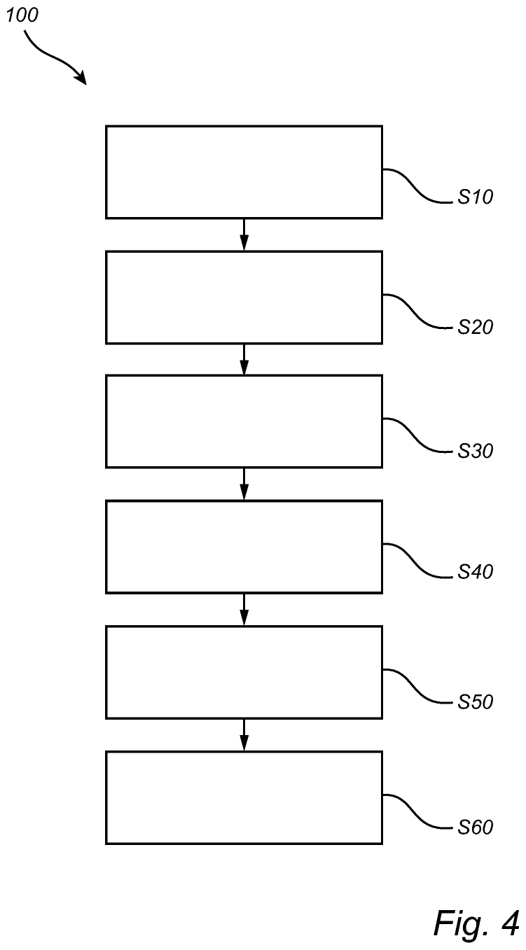

Turning now to FIG. 2, there is depicted parts of the control system 90, according to one example embodiment. The control system 90 is here arranged as a component of the vehicle combination 10, as shown in FIGS. 1a and 1b. The control system 90 is configured to control transfer of electrical energy between the truck 20 and the dolly vehicle 30. The control system 90 comprises processing circuitry 92 comprised in the vehicle combination 10. The processing circuitry 92 is configured to perform the steps of the method 100 as will be further described in relation to FIG. 4. While parts of the control system 90 and the processing circuitry 92 may be comprised in different locations of the vehicle combination depending on type of vehicles of the vehicle combination, it may generally be an advantage to incorporate one or more sub-control units in each one of the vehicles making up the vehicle combination so as to provide for an efficient control of the energy transfer between the vehicles.

As such, the control system 90, as exemplified in FIG. 2, comprises a first vehicle control unit 90a comprised with the truck 20 and a second vehicle control unit 90b comprised with the dolly vehicle 30. Each one of the control units 90a and 90b generally comprises processing circuitry 92a and 92b which may each include a microprocessor, microcontroller, programmable digital signal processor or another programmable device. Each one of the processing circuitry 92a and 92b may also, or instead, each include an application specific integrated circuit, a programmable gate array or programmable array logic, a programmable logic device, or a digital signal processor. Where each one of the processing circuitry 92a and 92b includes a programmable device such as the microprocessor, microcontroller or programmable digital signal processor mentioned above, the processor may further include computer executable code that controls operation of the programmable device. It should be understood that all or some parts of the functionality provided by the one or more of the processing circuitry 92a and 92b may be at least partly in communication with the described components of the control system 90.

Further, in an autonomous vehicle combination, it may be noted that the control system may operate the vehicle combination 10 in a common way when the truck 20 and the dolly vehicle 30 are in a coupled configuration, as shown in e.g. FIG. 1a, while the truck 20 and the dolly vehicle 30 may generally be operated by their corresponding first vehicle control unit 90a and second vehicle control unit 90b in an uncoupled mode, i.e. when the vehicles are operated independent from each other, as illustrated in FIG. 1b. When the truck 20 and the dolly vehicle 30 form the vehicle combination 10, the first vehicle control unit 90a of the truck 20 is generally the “master”, while the dolly vehicle 30 is configured to be autonomous when disconnected from the truck etc. Hence, as long as the truck 20 is connected to the dolly vehicle 30, the truck 20 acts as master, while the one or more dolly vehicles operate in a slave mode. When the dolly vehicle 30 decouples from the master control unit 90a, however, the slave mode in the dolly vehicle 30 is shifted to master mode, and the dolly vehicle is operable as an autonomous vehicle. The communication between the master and slave mode control units 90a and 90b is either via wireless connection such as a unit to unit (U2U) communication or via some form of wired communication such as Ethernet communication between units.

While referring again to the example embodiment in FIG. 2, the coupling for transferring energy between the truck 20 and dolly vehicle 30 is an inductive coupling 52. The inductive coupling 52 is provided in the form of a common type of inductive coupling having a first coil 52a arranged at the truck 20 and a second coil 52b arranged at the dolly vehicle 30.

In order to handle the transfer of the energy between the vehicles via the inductive coupling, each one of the vehicles 20 and 30 comprises corresponding converters. Hence, the truck 20 here comprises a conventional bidirectional DC/AC converter 94a for power conversion. Analogously, the dolly vehicle 30 comprises a corresponding bidirectional DC/AC converter 94b for power conversion.

The truck 20 also comprises a conventional charge controller 95a that is in electrical connection with the bidirectional DC/AC converter 94a. The charge controller 95a is also in electrical connection with the ESS 24. If the truck 20 is an electric truck, as shown in FIGS. 1a and 1b, the bidirectional DC/AC converter 94a is generally also in electrical connection with the electric machine 22 (although not shown in FIG. 2). Moreover, each one of the above components are in communication with the first vehicle control unit 90a.

Analogously, the dolly vehicle 30 comprises a corresponding conventional charge controller 95b that is in electrical connection with the bidirectional DC/AC converter 94b. The charge controller 95b is also in electrical connection with the ESS 34. Further, the bidirectional DC/AC converter 94b is in electrical connection with the electric machine 32. The electric machine may here include a motor controller for coordinating the operation of the electric motor of the electric machine, as is commonly known in the art. Moreover, each one of the above components are in communication with the second vehicle control unit 90b.

The first and second vehicle control units 90a and 90b are also in communication with each other via a communication interface 80. The communication interface is here a common data bus. However, the communication between the first and second vehicle control units 90a and 90b can either be by wire or by wireless link, such as a communications network defined by the third-generation partnership program, 3GPP. Examples of such networks include 4G, 5G and 6G communication networks, as well as networks in the 802.11 family, in particular 802.11p.

Each one of the first and second vehicle control units 90a and 90b are configured to communicate with the above components as well as with each other. The control system 90 has also access to relevant vehicle information from the truck 20 and dolly vehicle 30, as mentioned below. In addition, or alternatively, the control system 90 may comprise a memory for storing such information. Examples of control signals and/or data that may be communicated to the control system 90 are operational parameters for determining when and if a transfer of electrical energy is to be initiated between the truck 20 and the dolly vehicle 30 during a driving sequence in order to perform transportation missions for the vehicle combination 10, including transportation missions for the truck 20 and the dolly vehicle 30 as independent vehicle units, as will be further described below.

To sum up, when a vehicle combination is formed between the truck 20 and the dolly vehicle 30, the operation of the dolly vehicle 30 is mainly controlled by the control units 90a and 90b and the corresponding processing circuitry 92a and 92b. Furthermore, the direction controllers of the control units, the charge controllers 95a and 95b and a motor controller (not shown) of the electric machine 32 are configured to exchange information via the communication interface 80, such as a common data bus. Also, the bidirectional DC/AC converters 94a and 94b here exchange data through a bus, which may correspond to the communication interface 80. When the truck 20 acts as master, the control unit 90a informs the direction controllers of the control system 90 when it is time for breaking or accelerating. The control system 90 also have data on the currents 11 and 12, see FIG. 2, and information on the direction of the current 11 and 12 through the buses between the charge controllers 95a and 95b. By analysing the data from the above components, the direction controllers of the control system 90 may either change the direction of the current or stop the power exchange between the dolly 30 and the truck 20 based on the proposed method and energy transfer schedule as described herein. In particular, the control system 90 controls the direction of energy transfer in accordance with the conditions, e.g. an energy transfer schedule, as described herein.

In FIG. 2, the transfer of electrical energy is performed in the inductive coupling 52 between the truck 20 and the dolly vehicle 30. However, the example of the configuration in FIG. 2, including the operations of the control system 90, is only one conceivable example on how to transfer electrical energy between the vehicles, e.g. from the dolly vehicle 30 to the truck 20.

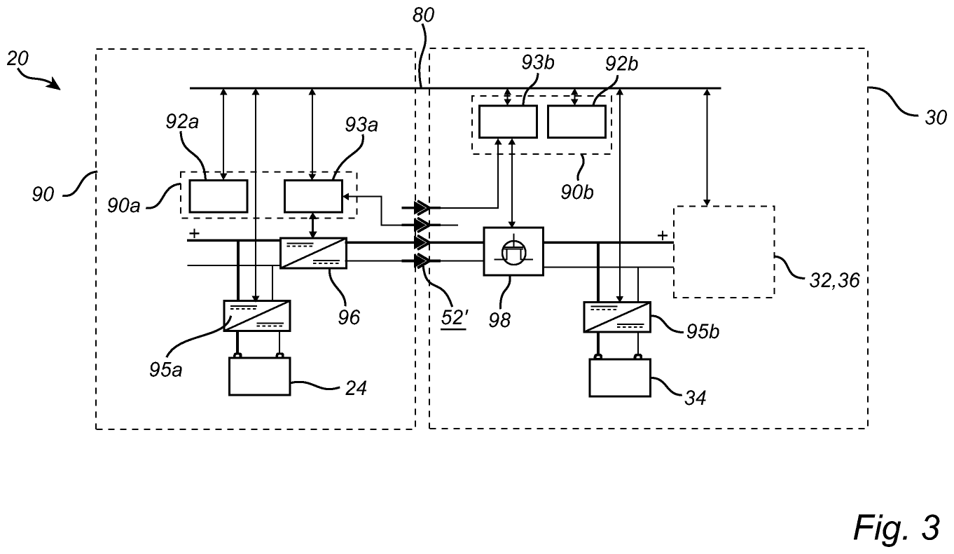

In another example, the transfer of energy between the vehicles 20 and 30, e.g. from the dolly vehicle 30 to the truck 20 may be handled in a conventional conductive coupling 52′, as exemplified by the configuration illustrated in FIG. 3. The conductive coupling is here provided in the form of a pair of conventional connectors arranged on the respective vehicles. The example embodiment in FIG. 3 is rather similar to the example embodiment in FIG. 2 in terms of integration and operation. However, due to that the coupling between the vehicles 20 and 30 is here a conductive coupling 52′, another difference is that the example embodiment in FIG. 3 comprises a DC/DC converter 96 arranged in the truck 20. The DC/DC converter 96 is arranged in electrical connection with the coupling 52′ and with the charge controller 95a. The DC/DC converter 96 may also be arranged in electrical connection with the electric machine 22. To this end, the bidirectional DC/AC converters in FIG. 2 have been replaced with the DC/DC converter so as to convert a source of direct current from one voltage level to another voltage level, as is commonly known in the art. Further, for a conductive coupling, the control system 90 may also include a safety mechanism so that power is only transferable if (when) the conductive coupling 52′ is established between the vehicles 20 and 30. As such, the control system 90 also comprises a switch 98 arranged in the dolly vehicle 30. The switch 98 may be a conventional MOSFET switch for controlling and interrupting the current in the electrical connection if there is no contact between the connectors of the conductive coupling 52′.

In FIG. 3, when a vehicle combination is formed between the truck 20 and the dolly vehicle 30, the operation of the dolly vehicle 30 is mainly controlled by the control units 90a and 90b and the corresponding processing circuitry 92a and 92b. Furthermore, the direction controllers 93a and 93b of the control units, the charge controllers 95a and 95b and a motor controller (not shown) of the electric machine 32 are configured to exchange information via the communication interface 80. Also, the DC/DC converter 96 here exchanges data with the control unit 90a through the communication interface 80, or via another data bus. For human and safety reasons, and also for extending the lifetime of the conductive coupling 52′, the switch 98 is operable to postpone energy transfer to the conductive coupling 52′ from the ESS 34 until a connection has been established and detected. The DC/DC converter 96 may generally provide the same functionality on the truck 20. To this end, the DC/DC converter 96 and the switch 98 are operable to block or prevent any voltages on the connectors of the conductive coupling a connection has been detected. When there is a connection between the truck 20 and the dolly vehicle 30, the control system 90 is configured to control energy transfer in the conductive coupling 52′ from the dolly vehicle 30 to the truck 20 in accordance with the method described in relation to FIG. 4. In addition, in FIG. 3, the operational parameter may here also contain data relating to determined voltages and currents levels in the DC/DC converter 96.

Similar to the example in FIG. 2, when the truck 20 acts as master, the control unit 90a informs the direction controllers of the control system 90 when it is time for breaking or accelerating. The control system 90 also have data on the currents 11 and 12, see FIG. 3, and information on the direction of the current 11 and 12 through the buses between the charge controllers 95a and 95b. By analysing the data from the above components, the direction controllers of the control system 90 may either change the direction of the current or stop the power exchange between the dolly 30 and the truck 20 based on the proposed method and energy transfer schedule as described herein.

Except for the above difference, the example embodiment in FIG. 3 may generally comprise any one of the components described above in relation to the example embodiment in FIG. 2.

Turning again to the control system 90, the one or more control units 90a and 90b are in communication with each other via the communication interface 80. Typically, each one of the vehicles 20 and 30 comprises respective transceivers (although not shown) for receiving information and data. Thus, the communication interface 80 provides for transmitting data between the truck 20, dolly vehicle 30, trailer 70 and a remote server (not shown). Such arrangement of communication can be established in several different ways. By way of example, the truck 20 is equipped with a transceiver (not shown) configured to establish a communication with another transceiver comprised with any the dolly vehicles, trailers and remote server. Each transceiver may comprise a transmitter side and a receiver side or may constitute a combined device. Each transceiver may comprise or be connected to at least one antenna, which may be mounted on top of the corresponding or underneath, or in a different suitable position. The antenna may comprise multiple antenna elements, especially on the receiver side.

For transportation missions for vehicle combinations comprising one or more autonomous vehicles, such as the vehicle combination in FIGS. 1a and 1b, the control system 90 often receives a request for a common transportation mission where the vehicles 20, 30 need to be operated in a coupled state along a driving segment as well as one or more transportation missions where the vehicles need to be operated in a decoupled state along a driving segment. As such, the transportation mission data generally contains data for decoupling the dolly vehicle 30 from the truck 20 in order to complete the common transportation mission. By way of example, the last part of a transportation mission may include a part where the truck 20 and dolly vehicle 30 should separate from each other and further be controlled to be operated independently in the decoupled mode, such as when the truck 20 needs to be parked at one location of the logistics area and the dolly vehicle 30 needs to be parked at another location of the same logistics area, or in another logistics area. In addition, or alternatively, the transportation mission data may contain data that the cargo transported by the dolly vehicle 30 should be delivered to another destination than the cargo transported by the truck 20. In this part of the transportation mission, the dolly vehicle 30 also needs to be operated independently from the truck 20 at least for a substantive part. To this end, the control system 90 is configured to receive transportation mission data containing data indicating a need for operating any one of the truck 20 and the dolly vehicle 30 as independent vehicles at one or more occasions during the transportation mission.

Turning thus to the function of the control system 90, the control system 90 is configured to control electrical energy transfer in the coupled vehicle combination 10 as illustrated in FIG. 1b. One example of a number of sequences for controlling electrical energy transfer in the vehicle combination will now be further described in relation to FIG. 4, which shows a flow-chart of the steps of a method performed by the control system 90.

Initially, the control system 90 receives S10 transportation mission data for the truck 20 and the dolly vehicle 30. The transportation mission data may contain a common transportation mission for the coupled vehicle combination 10, a transportation mission for the truck 20, a transportation mission for the dolly vehicle 30, and/or a combination thereof. The transportation mission data can e.g. be transferred from the remote server or a remote-control unit. The remote-control unit may, e.g., be comprised in a control tower arranged to control a fleet of powered dolly vehicles in a cargo terminal or another logistics area for the truck 20. In other examples, data relating to the transmission mission may be inputted directly by the driver of the truck 20 at an appropriate time before the start of the transportation mission.

The transportation mission data contains at least information of a vehicle coupled driving segment in which the truck and dolly vehicle 20, 30 are in the coupled vehicle combination for performing a part of a transportation mission and information of any vehicle uncoupled driving segments in which one of the truck and dolly vehicles 20, 30 is operated in the uncoupled state from the other one for performing another part of the transportation mission.

The transportation mission is here a common transportation mission for the vehicle combination 10. Hence, by way of example, the common transportation mission comprises a mission-characteristic for the vehicle combination 10. The mission-characteristic of the vehicle combination may typically comprise any one of an assignment instruction for the vehicle combination, a cargo space-requirement for the vehicle combination, a pick-up location(s) of the cargo, a pick-up time for the cargo, a delivery time for the cargo, a delivery location(s) of the cargo, and data indicating type of cargo. In addition, or alternatively, the mission-characteristic of the vehicle combination 10 comprises data indicating type of truck.

Next, as illustrated in FIG. 4, the control system 90 determines S20 a state-of-charge, SOC, value of the ESS of the truck 20 and a SOC value of the ESS of the dolly vehicle 30. The SOC for any one of the vehicles can be determined based on status updates from the ESS as commonly known in the art.

Further, the control system 90 determines S30 an energy consumption for each one of the truck 20 and the dolly vehicle 30 for completing the at least one vehicle coupled driving segment.

The energy consumption for the truck 20 in the at least one vehicle coupled driving segment may be calculated based on the total weight of the truck 20 and the total weight of the dolly vehicle 30 including any payload on the truck 20 and the dolly vehicle 30. It should be readily appreciated that also the weight and payload of any trailer connected to any one of the truck 20 and the dolly vehicle 30 is included in the weight calculations for determining the energy consumption of the truck 20.

The energy consumption for the dolly vehicle 20 in the at least one vehicle coupled driving segment may be calculated based on the total weight of the dolly vehicle 30 including any payload on the dolly vehicle 30. It should be readily appreciated that also the weight and payload of any trailer connected to the dolly vehicle 30 is included in the weight calculations for determining the energy consumption of the dolly vehicle 30. It should be noted that the impact from the weight on the energy consumption of the dolly vehicle 30 in the at least one vehicle coupled driving segment may also be affected by the connection to the truck 20. Hence, for obvious reasons, the energy consumption of the dolly vehicle 30 in the at least one vehicle coupled driving segment may generally be less than the energy consumption of the dolly vehicle 30 during a similar driving segment in an uncoupled state relative to the truck 20.

In addition, or alternatively, the provision of determining an energy consumption for each one of the truck 20 and the dolly vehicle 30 for the vehicle coupled driving segment may further comprise using vehicle and driving characteristics for a previous transportation along the corresponding vehicle coupled driving segments.

The next action for the procedure is then, at the control system 90, to determine S40 an energy consumption for each one of the truck 20 and the dolly vehicle 30 for completing the vehicle uncoupled driving segments.

By way of example, the energy consumption of an individual vehicle of any one of the truck 20 and the dolly vehicle 30 in any vehicle uncoupled driving segments is calculated on the basis of the individual weight of the individual vehicle including any payload on the individual vehicle. It should be readily appreciated that also the weight and payload of any trailer connected to any one of the truck 20 and the dolly vehicle 30 is included in the weight calculations for determining the energy consumption of the individual vehicle.

Typically, the energy consumption for each one the truck 20 and the dolly vehicle 30 for the vehicle uncoupled driving segments is further determined by using vehicle and driving characteristics for a previous transportation along any one of the corresponding vehicle uncoupled driving segments.

The total weight of a vehicle may be defined as the sum of the kerb weight (curb weight) and any payload loaded on the vehicle. For example, the total weight of the truck 20 is defined by its vehicle weight and cargo weight relating to the transportation mission. In addition, the energy consumption may include a factor relating to the distribution of the cargo weight. Analogously, the total weight of the dolly vehicle 30 is defined by its vehicle weight and cargo weight relating to the transportation mission. In addition, the energy consumption may include a factor relating to the distribution of the cargo weight. In a coupled vehicle combination, the total weight of the dolly vehicle 30 is particularly relevant because it will not only affect the energy consumption of the dolly vehicle, but also the energy consumption of the truck 20 as the truck 20 must be powered to also handle the loads from the dolly vehicle 30 in the coupled mode. In addition, the truck 20 may also need to be powered to handle the loads from any additional trailer and/or semitrailer connected to the truck 20 and/or the dolly vehicle 30.

Optionally, the control system 90, also determines the energy consumption for the truck 20 and dolly vehicle 30, respectively, to complete the transportation missions using the received data for the transportation missions and route information for completing the mission transportations.

Finally, the control system 90 provides S50 an energy transfer schedule for the transportation mission comprising one or more energy transfer operations for transferring energy between the truck 20 and dolly vehicle 30. The energy transfer schedule is provided on the basis of the determined SOC values and determined energy consumptions as described herein.

Moreover, transportation mission data containing information of a vehicle coupled driving segment here also comprises route information. Analogously, transportation mission data containing information of any vehicle uncoupled driving segments may also comprise route information. In other words, in one example, the transportation mission data and route information are used as input data to determine the vehicle couple driving segment and any vehicle uncoupled driving segments for the vehicles of the vehicle combination. Route information here generally comprises any one of the following data: a planned driving route for the vehicles for completing the mission transportations; data retrieved from a general map data (e.g. when exact route info is not available), e.g. a geographical zone or road type present/ahead; distance to a charging station, with corresponding energy consumption indicated; data retrieved from specific mission information (energy consumption predicted based on reference data for the specific route segment or complete mission). In addition, or alternatively, route information may further contain any one of the following data: data relating to an upcoming vehicle path, such as a downhill and uphill path; data relating to a change in vehicle speed, data relating to a change in acceleration.

As such, the control system 90 is here also configured to receive route information. Route information can for example be acquired from an online or offline navigation system (not illustrated) of the vehicle. Route information may also be acquired from a remote server or a cloud environment using a wireless connection of the vehicle. Furthermore, certain route information may be provided by the driver of the truck. In addition to the destination, which is typically determined by the driver, the driver may also provide information describing planned stops along the route. The planned stop may for example be a planned lunch break or other stops.

In addition, or alternatively, the energy consumption for any one of the truck 20 and dolly 30 is determined on the basis of vehicle and driver characteristics for previous completed transportation missions. Such parameters may e.g. include historical data, theoretical data etc.

In addition, or alternatively, the energy consumption for any one of the truck 20 and dolly vehicle 30 may be determined on the basis of predicted driver characteristic data.

In addition, or alternatively, the energy consumption for any one of the truck 20 and dolly vehicle 30 may be determined on the basis of at least one of the following additional data: data indicating type of vehicle of the vehicle combination, data indicating a braking system of the vehicle combination (including the braking system of the truck 20 as well as the braking system of the dolly vehicle 30), characteristics of the electric machine in any one of the vehicles, type of auxiliary vehicle power system in any one of the vehicles. The braking system may for instance include braking by an electromotor, electromagnetic braking and/or a mechanical brake system.

In addition, or alternatively, the energy consumption for any one of the truck 20 and dolly vehicle 30 is determined on the basis of data relating to environmental conditions. Accordingly, the control system 90 is configured to determine energy consumption and/r or adjust the determined energy consumption based on the environmental conditions.

The control system 90 can be configured to control the electrical energy transfer between the truck 20 and the dolly vehicle 30 in several different manners in view of the predicted parameters and conditions as mentioned herein. As such, the energy transfer schedule for the transportation mission may contain a number of different energy transfer operations between the vehicles in view of the various vehicle coupled driving segment(s) as well as the various vehicle uncoupled driving segment.

In addition, the energy transfer schedule for the transportation mission may contain a number of different energy transfer operations between the vehicles in view of the occurrence, duration and the mutual order of the vehicle coupled driving segment(s) and the vehicle uncoupled driving segment. In the following, a number of examples on different energy transfer operations of the energy transfer schedule will be described in more detail. While it should be noted that the energy transfer schedule may occasionally only contain one of these examples, the control system 90 may typically be configured to operate the vehicles and control the energy transfer between the vehicles in a number of ways in view of the energy consumption of the vehicles and specific transportation mission data, as previously described.

By way of example, if the transportation mission data contains information for the dolly vehicle 30 to perform a vehicle uncoupled driving segment after the at least one vehicle coupled driving segment, the control system 90 performs an energy transfer operation where energy is transferred from the truck 20 to the dolly vehicle 30 if the determined SOC value of the dolly vehicle 30 is below a threshold indicating a minimum SOC level and if the determined SOC value of the truck 20 is above a threshold indicating a surplus level for the truck 20. To this end, the method provides a control strategy for the dolly vehicle 30 and an uncoupled driving segment after the at least one vehicle coupled driving segment.

Typically, in this example, the energy transfer schedule comprises determining a duration for the transfer of energy from the truck 20 to the dolly vehicle 30 during the vehicle coupled driving segment.

In addition, or alternatively, if the transportation mission data contains information for the truck 20 to perform a vehicle uncoupled driving segment after the at least one vehicle coupled driving segment, the control system 90 performs an energy transfer operation where energy is transferred from the dolly vehicle 30 to the truck 20 if the determined SOC value of the truck 20 is below a threshold indicating a minimum SOC level and if the determined SOC value of the dolly vehicle 30 is above a threshold indicating a surplus level for the dolly vehicle 30. To this end, the method provides a control strategy for the truck 20 and an uncoupled driving segment after the at least one vehicle coupled driving segment.

Typically, in this example, the energy transfer schedule may comprise determining a duration for the transfer of energy from the dolly vehicle 30 to the truck 20 during the vehicle coupled driving segment.

In addition, or alternatively, if the transportation mission data contains information for any one of the truck 20 and dolly vehicle 30 to perform a vehicle uncoupled driving segment prior to the at least one vehicle coupled driving segment, the control system 90 is configured to determine if the corresponding determined vehicle SOC values are sufficient for the vehicle uncoupled driving segment on the basis of the corresponding determined energy consumptions for the vehicle uncoupled driving segment. To this end, the method provides a control strategy for the vehicles 20, 30 for an uncoupled driving segment prior to the at least one vehicle coupled driving segment.

Optionally, the control system 90 may be configured to always compare and control all predicted energy transfer operations during the transportation mission, in particularly at the start of the transportation mission. Based on this overall comparison the control system 90 may determine that a particular energy transfer operation between the vehicles is more critical than another determined energy transfer operation. By way of example, the control system 90 may decide that a transfer of electrical energy from the truck 20 to the dolly vehicle 30 may only be initiated if the determined SOC value of the dolly vehicle 30 is below a threshold indicating a minimum electrical energy need for the dolly vehicle 30 and if the determined SOC value of the truck 20 is above a threshold indicating an energy surplus level for the truck. The threshold indicating a minimum electrical energy need for the dolly vehicle 30 is generally defined on the basis of the predicted electrical energy consumption, as mentioned above. Analogously, the threshold indicating an energy surplus level for the truck is generally defined on the basis of the predicted electrical energy consumption, as mentioned above.

In other words, the control system 90 estimates the need for a transfer of electrical energy between the truck and the dolly vehicle, and subsequently controls direction of the transfer of electrical energy between the truck 20 and the dolly vehicle 30 based on the predicted transportation mission, the predicted SOC values and the predicted electrical energy consumptions of the truck 20 and the dolly vehicle 30. In particular, the processing circuitry 92a and 92b of the vehicle control units 90a and 90b, each comprises a corresponding direction controller 93a and 93b for determining and controlling the direction of the energy transfer between the truck 20 and the dolly vehicle 30 based on the prediction. More specifically, the control system 90 operates the direction controllers 93a and 93b either to block or change the direction of energy in the coupling based on the needed energy in the truck 20.

That is, the control system 90 decides if the dolly vehicle 30 should transfer energy to the truck 30, or vice versa. In particular, the control system 90 controls the direction of energy transfer in accordance with the SOC level conditions above.

By way of example, in order to handle these types of transportation missions, the control system 90 is configured to determine to operate the dolly vehicle 30 in a decoupled mode from the truck 20, and further configured to determine to initiate transfer of electrical energy from the truck 20 to the dolly vehicle 30 prior to setting the dolly vehicle 30 into the decoupled mode. By way of example, the control system 90 may have indicated that one of the vehicles may not be sufficiently charged to fulfil the transportation mission. Hence, the control system 90 initially estimates if the determined SOC value of the dolly vehicle 30 is below the threshold indicating a minimum electrical energy need for the dolly vehicle 30 and if the determined SOC value of the truck 20 is above the threshold indicating an energy surplus level for the truck 20 on the basis of the transportation mission and received route information. In order to assist in determining the need for transfer electrical energy between the vehicles during such transportation mission, it may also be useful to obtain data relating to the last part of the transportation mission in the logistics area. Based on the above estimations and predictions, the control system 90 is capable of determining if the vehicles can fulfil the transportation mission without any energy transfer or if energy transfer should be initiated from one of the vehicles to the other one of the vehicles. While it may be more common to transfer energy from the truck 20 to the dolly vehicle 30, it may also in some situations be an opposite energy transfer, i.e. from the dolly vehicle 30 to the truck 20, as also mentioned above.

In order words, for a transportation mission including the above functionality of a need for driving the dolly vehicle 30 independently from the truck 20 so as to complete the mission, the control system 90 typically determines the need for operating the dolly vehicle 30 as an independent vehicle at any occasion during the transportation mission based on relevant data received at the control system 90 from the remote control unit. Hence, the control system 90 is here configured to determine the energy consumption for any one of the truck 20 and dolly vehicle 30 on the basis of data indicating a need for operating the secondary vehicle as an independent vehicle at any occasion during the transportation mission, the determined SOC values and determined energy consumptions, as described herein.

Optionally, if the SOC values of the truck 20 and dolly vehicle 30 are insufficient for completing the transportation mission on the basis of the determined SOC values and determined energy consumptions, also including a predicted aggregated electrical energy consumption of the vehicles 20, 30, the control system 90 is here configured to generate a precautionary action to an operator containing at least a recommendation to charge any one of the truck 20 and dolly vehicle 30 during the transportation mission.

It should be noted that in an operational situation where the above conditions are not met, the control system 90 may generally control that no electrical energy is transferred between the vehicles 20, 30 unless there is no deviation of the determined SOC values with the thresholds.

It may also be noted that while the control system 90 may generally provide the energy transfer schedule for the transportation mission based on the above determined SOC values and determined energy consumptions of the vehicles 20, 30, the control system may also at least partly determine the energy transfer schedule for the transportation mission based on a known relation between required vehicle SOC and vehicle electrical energy consumption. Such known relation between required vehicle SOC and vehicle electrical energy consumption can e.g. be based on commonly known theories between SOC and energy consumption to adjust the energy transfer schedule in view of other conditions that may have an impact on the process of estimating energy consumption and SOC values. Therefore, a known relation between required vehicle SOC and vehicle electrical energy consumption may be used so as to further improve the accuracy of the estimation of relation between SOC and energy consumption.

By way of example, the known relation can be indicative of a threshold value that reflects a critical value of the known relation between required vehicle SOC and vehicle electrical energy consumption. Hence, if the relation between the determined SOC values and the predicted electrical energy consumption of the truck 20 and dolly vehicle 30 is above the threshold, i.e. the critical value, a transfer of electrical energy is initiated from one of the vehicle to the other vehicle.

In view of the above, the method may also comprise the step of providing a known relation between required vehicle SOC and vehicle electrical energy consumption.

In addition, or alternatively, the known relation may further comprise a predetermined relationship and a statistical model defining a relation between SOC and electrical energy consumption based on previous historical data for similar vehicles. By way of example, the know relation is determined from a conventional data-based modelling method which aims to apply actually collected data to establish the data-based model.

The electrical energy consumption may further be calculated from acquired driving data for each vehicle both in a coupled mode and in a decoupled mode.

The energy transfer schedule may comprise initiating energy transfer between the primary vehicle and the secondary vehicle prior to commencing the transportation mission or during the transportation mission.

The control system 90 may further be configured to receive driving data or driver data from any one of the truck and dolly vehicle during the vehicle coupled driving segment and any one of the vehicle uncoupled driving segments. In addition, the control system 90 may be configured to adjust the one or more energy transfer operations of the energy transfer schedule on the basis of the received driving data or driver data.

In addition, or alternatively, the provision of providing an energy transfer schedule for the transportation mission may comprise adjusting the one or more energy transfer operations on the basis of at least one of the following additional data: data indicating type of vehicle of the vehicle combination, data indicating type of braking system of the vehicle combination, characteristics of the electric machine in any one of the vehicles, type of auxiliary vehicle power system in any one of the vehicles.

In addition, or alternatively, the provision of providing an energy transfer schedule for the transportation mission may comprise adjusting the one or more energy transfer operations on the basis of data relating to environmental conditions.

As mentioned above, the transportation mission data may comprise route information describing a route from a starting point to a destination.

To sum up, the control system 90 is configured to receive transportation mission data for the primary and secondary vehicle 20, 30, the transportation mission data containing information of the vehicle coupled driving segment in which the primary and secondary vehicles 20, 30 are in a coupled vehicle combination for performing a part of the transportation mission and information of any vehicle uncoupled driving segments in which one of the primary and secondary vehicles 20, 30 is operated in an uncoupled state from the other one for performing another part of the transportation mission; determine a state-of-charge, SOC, value of the ESS of the primary vehicle 20 and a SOC value of the ESS of the secondary vehicle 30, respectively; determine an energy consumption for each one of the primary and secondary vehicles 20, 30 for completing the at least one vehicle coupled driving segment; determine an energy consumption for each one of the primary and secondary vehicles 20, 30 for completing the vehicle uncoupled driving segments; and, on the basis of the determined SOC values and determined energy consumptions, providing an energy transfer schedule for the transportation mission comprising one or more energy transfer operations for transferring energy between the primary and secondary vehicles 20, 30.

Hence, in order to sum up, the method according to the example embodiments, reference is made to FIG. 4, which is a flowchart of a method 100 for controlling the above described electrical energy transfer in a vehicle combination according to an example embodiment. The method is typically implemented by the control system 90, as described in relation to FIGS. 2 and 3. During operation of the vehicle combination, one embodiment of the method 100 here comprises:
receiving S10 transportation mission data for the primary and secondary vehicle, the transportation mission data containing information of a vehicle coupled driving segment in which the primary and secondary vehicles are in a coupled vehicle combination for performing a part of a transportation mission and information of any vehicle uncoupled driving segments in which one of the primary and secondary vehicles is operated in an uncoupled state from the other one for performing another part of the transportation mission;
determining S20 a state-of-charge, SOC, value of the ESS of the primary vehicle and a SOC value of the ESS of the secondary vehicle;
determining S30 an energy consumption for each one of the primary and secondary vehicles for completing the at least one vehicle coupled driving segment;
determining S40 an energy consumption for each one of the primary and secondary vehicles for completing the vehicle uncoupled driving segments; and
on the basis of the determined SOC values and determined energy consumptions, providing S50 an energy transfer schedule for the transportation mission comprising one or more energy transfer operations for transferring energy between the primary and secondary vehicles.

Subsequently, the method optionally comprises controlling S60 the energy transfer between the primary and secondary vehicles based on the provided energy transfer schedule. By way of example, the control system is configured to control the energy transfer between the primary and secondary vehicles according to any one of the control strategies mentioned above.

Typically, although strictly not required, the method also comprises receiving a request from the remote-control unit, where the request contains data relating to the transportation mission.

Optionally, the method further comprises determining to operate the secondary vehicle in a decoupled mode from the primary vehicle, and determining to initiate transfer of electrical energy from the primary vehicle to the secondary vehicle prior to setting the secondary vehicle into the decoupled mode. Optionally, the method further comprises, if the SOC values of the primary and secondary vehicles are insufficient for completing the transportation missions on the basis of the determined energy consumption of the primary and secondary vehicles, generating a precautionary action to an operator containing at least a recommendation to charge any one of the primary and secondary vehicles during the transportation missions.

The steps of the method are generally performed by the control system 90, as described above in relation to FIG. 2. Hence, it should be noted that the embodiments of the method may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data that cause a general-purpose computer, special purpose computer, or special purpose processing machines to perform a certain function or group of functions.

It should also be noted that the control system 90, and each one of the corresponding control units 90a and 90b, may for example be an electronic control unit (ECU), comprised with the vehicle combination 10, possibly manifested as a general-purpose processor, an application specific processor, a circuit containing processing components, a group of distributed processing components, a group of distributed computers configured for processing, a field programmable gate array (FPGA), etc. The control system 90 and each one of the corresponding control units 90a and 90b may be or include any number of hardware components for conducting data or signal processing or for executing computer code stored in memory. The memory may be one or more devices for storing data and/or computer code for completing or facilitating the various methods described in the present description. The memory may include volatile memory or non-volatile memory. The memory may include database components, object code components, script components, or any other type of information structure for supporting the various activities of the present description. According to an exemplary embodiment, any distributed or local memory device may be utilized with the systems and methods of this description. According to an exemplary embodiment the memory is communicably connected to the processor (e.g., via a circuit or any other wired, wireless, or network connection) and includes computer code for executing one or more processes described herein.

Also, although the figures may show a specific order of method steps, the order of the steps may differ from what is depicted. In addition, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. For example, the generalization of the present vehicle combinations to include additional vehicles, as described above, remains within the scope of the present invention. Additionally, variations to the disclosed embodiments can be understood and effected by the skilled person in practicing the claimed inventive concept, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. A method for controlling electrical energy transfer in a vehicle combination comprising at least a primary vehicle articulated coupled to a secondary vehicle so as to form a coupled vehicle combination, each one of the primary and the secondary vehicles having an electric machine and an energy storage system (ESS), the method comprising:
receiving transportation mission data for the primary and the secondary vehicle, transportation mission data containing information of a vehicle coupled driving segment in which the primary and the secondary vehicles are in a coupled vehicle combination for performing a part of a transportation mission and information of any vehicle uncoupled driving segments in which one of the primary and the secondary vehicles is operated in an uncoupled state from the other one for performing another part of the transportation mission;
determining a state-of-charge (SOC) value of the ESS of the primary vehicle and a SOC value of the ESS of the secondary vehicle;
determining an energy consumption for each one of the primary and the secondary vehicles for completing the at least one vehicle coupled driving segment;
determining an energy consumption for each one of the primary and the secondary vehicles for completing any vehicle uncoupled driving segments; and
on the basis of the determined SOC values and determined energy consumptions, providing an energy transfer schedule for the transportation mission comprising one or more energy transfer operations for transferring energy between the primary and the secondary vehicles.

2. The method of claim 1, wherein if the transportation mission data contains information for the secondary vehicle to perform a vehicle uncoupled driving segments after the at least one vehicle coupled driving segments:
the one or more energy transfer operations comprises transferring energy from the primary vehicle to the secondary vehicle if the determined SOC value of the secondary vehicle is below a threshold indicating a minimum SOC level and if the determined SOC value of the primary vehicle is above a threshold indicating a surplus level for the primary vehicle.

3. The method of claim 2, wherein the energy transfer schedule comprises determining a duration for the transfer of energy from the primary vehicle to the secondary vehicle during the vehicle coupled driving segment.

4. The method of claim 1, wherein:
if the transportation mission data contains information for the primary vehicle to perform a vehicle uncoupled driving segments after the at least one vehicle coupled driving segment:
the one or more energy transfer operations comprises transferring energy from the secondary vehicle to the primary vehicle if the determined SOC value of the primary vehicle is below a threshold indicating a minimum SOC level and if the determined SOC value of the secondary vehicle is above a threshold indicating a surplus level for the secondary vehicle.

5. The method of claim 4, wherein the energy transfer schedule comprises determining a duration for the transfer of energy from the secondary vehicle to the primary vehicle during the vehicle coupled driving segment.

6. The method of claim 1, wherein if the transportation mission data contains information for any one of the primary and the secondary vehicles to perform a vehicle uncoupled driving segments prior to the at least one vehicle coupled driving segment:
the method further comprises determining if the corresponding determined vehicle SOC values are sufficient for the vehicle uncoupled driving segments on the basis of the corresponding determined energy consumptions for the vehicle uncoupled driving segments.

7. The method of claim 1, wherein the energy consumption of an individual vehicle of any one of the primary and the secondary vehicles in any vehicle uncoupled driving segments is calculated on the basis of the individual weight of the individual vehicle including any payload on the individual vehicle.

8. The method of claim 1, wherein the energy consumption for the primary vehicle in the at least one vehicle coupled driving segment is calculated based on the total weight of the primary vehicle and the total weight of the secondary vehicle including any payload on the primary and the secondary vehicles.

9. The method of claim 1, wherein the energy transfer schedule comprises initiating energy transfer between the primary vehicle and the secondary vehicle prior to commencing the transportation mission or during the transportation mission.

10. The method of claim 1, further comprising receiving driving data or driver data from any one of the primary and the secondary vehicles during the vehicle coupled driving segment and any one of the vehicle uncoupled driving segments, and adjusting the one or more energy transfer operations of the energy transfer schedule on the basis of the received driving data or driver data.

11. The method of claim 1, wherein determining an energy consumption for each one of the primary and the secondary vehicles for the vehicle uncoupled driving segments further comprises using vehicle and driving characteristics for a previous transportation along any one of the corresponding vehicle uncoupled driving segments.

12. The method of claim 1, wherein determining an energy consumption for each one of the primary and the secondary vehicles for the vehicle coupled driving segment further comprises using vehicle and driving characteristics for a previous transportation along the corresponding vehicle coupled driving segments.

13. The method of claim 1, wherein providing an energy transfer schedule for the transportation mission comprises adjusting the one or more energy transfer operations on the basis of at least one of the following additional data: data indicating type of vehicle of the vehicle combination, data indicating type of braking system of the vehicle combination, characteristics of the electric machine in any one of the vehicles, type of auxiliary vehicle power system in any one of the vehicles.

14. The method of claim 1, wherein providing an energy transfer schedule for the transportation mission comprises adjusting the one or more energy transfer operations on the basis of data relating to environmental conditions.

15. The method of claim 1, wherein the transportation mission data comprises route information describing a route from a starting point to a destination.

16. The method of claim 1, further comprising controlling the energy transfer between the primary and the secondary vehicles based on the provided energy transfer schedule.

17. A control system comprising a processing circuitry configured to perform the method of claim 1.

18. A computer program comprising program code means for performing the method of claim 1 when the program is run on a computer or on a processing circuitry of a control system.

19. A computer readable medium carrying a computer program comprising program means for performing the method of claim 1 when the program means is run on a computer or on a processing circuitry of a control system.

20. A vehicle combination formed by a primary vehicle and a secondary vehicle, comprising the control system of claim 17.

21. The vehicle combination of claim 20, wherein the primary vehicle is an autonomous vehicle, such as an autonomous towing vehicle, autonomous tractor of a truck or an autonomous dolly vehicle.

22. The vehicle combination of claim 20, wherein the secondary vehicle is any one of an autonomous dolly vehicle and a trailer.

23. A vehicle for forming a vehicle combination with another vehicle, the vehicle comprising the control system of claim 17 when coupled to the another vehicle.
